(19) United States
(12) Patent Application Publication
(10) Pub. No.: US 2020/0393322 A1
(43) Pub. Date: Dec. 17, 2020

(54) AIRTIGHTNESS DETECTION SYSTEM AND AIRTIGHTNESS DETECTION METHOD

(71) Applicant: Goldtek Technology Co., Ltd., New Taipei City (TW)

(72) Inventors: KUAN-TING LIAO, New Taipei (TW); CHIH-FENG LIOU, New Taipei (TW); KUO-LIN CHIEN, New Taipei (TW)

(21) Appl. No.: 16/545,259

(22) Filed: Aug. 20, 2019

(30) Foreign Application Priority Data
Jun. 17, 2019 (TW) 108120958

(51) Int. Cl. G01M 3/26; G01M 3/00

(52) U.S. Cl. CPC G01M 3/26; G01M 3/007

(57) ABSTRACT

A system for detecting airtightness of an electronic device as a product includes a valve, a gas storage buffer tank connected to the product, and a pumping motor connected to the gas storage buffer tank for inputting compressed gas into the gas storage buffer tank. A pressure gauge is connected to the gas storage buffer tank for monitoring an instantaneous air pressure in the gas storage buffer tank, and a terminal is also included. The valve is between the product and the gas storage buffer tank for opening or closing an air passage therebetween. The terminal is connected to the pumping motor and the pressure gauge. A method for detecting airtightness is also disclosed.

### FIELD

The subject matter herein generally relates to quality testing, especially relates to an airtightness detection system and an airtightness detection method.

### BACKGROUND

Electronic products ought to have some waterproofing quality. Electronic products such as 3C products, consumer electronics, automotive electronics, and products that are often used in waterproof cameras, smart phones, wearable smart devices, waterproof headphones, and automotive devices.

However, many electronic products do not have complete or perfect protection against moisture. To ensure the complete waterproofing of an electronic product, the airtightness of the electronic product should also be tested.

### BRIEF DESCRIPTION OF THE DRAWINGS

Implementations of the present technology will now be described, by way of embodiments, with reference to the attached figures.

FIG. 1 is a schematic block diagram of an airtightness detection system in an embodiment.

FIG. 2 is a schematic flow chart of an airtightness detection method in an embodiment.

FIG. 3 and FIG. 4 show the results of detection (instantaneous pressure curve comparison diagram) of the airtightness detection system.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

The term “comprising,” when utilized, means “including, but not necessarily limited to”; it specifically indicates open-ended inclusion or membership in the so-described combination, group, series, and the like.

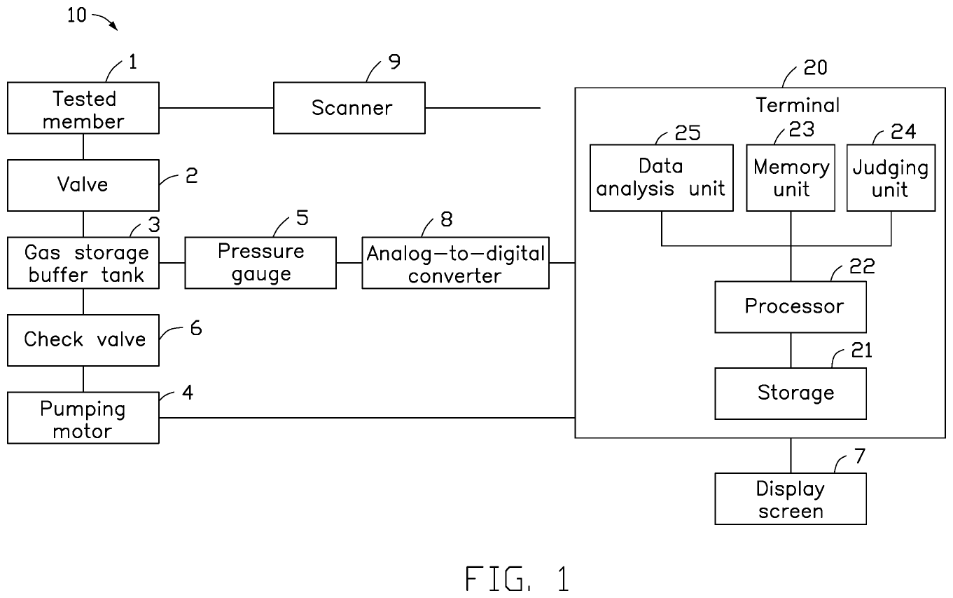

FIG. 1 shows an airtightness detection system 10 of an embodiment. The airtightness detection system 10 is configured to detect the airtightness of a product 1.

The airtightness detection system 10 at least includes a valve 2, a gas storage buffer tank 3, a pumping motor 4, a pressure gauge 5, and a terminal 20. The gas storage buffer tank 3 is connected to the product 1. The valve 2 is provided between the product 1 and the gas storage buffer tank 3 for opening or closing an air passage between the product 1 and the gas storage buffer tank 3. The pumping motor 4 is connected to the gas storage buffer tank 3 for inputting compressed gas into the gas storage buffer tank 3. The pressure gauge 5 is connected to the gas storage buffer tank 3 for monitoring an instantaneous air pressure in the gas storage buffer tank 3. The terminal 20 is connected to the pumping motor 4 and the pressure gauge 5.

In an embodiment, the product 1 is an electronic product, such as a mobile telephone. The product 1 is carried and positioned on a positioning fixture (similar to a fixing seat, not shown) during detection. To ensure the stability of the air pipes between the structures, the gas storage buffer tank 3, the pumping motor 4, and the pressure gauge 5 are preferably housed in the fixing seat.

In an embodiment, the connection between the gas storage buffer tank 3 and the product 1 may be achieved by an air pipe. Specifically, ends of the air pipe communicate with an air outlet of the gas storage buffer tank 3 and a test hole of the product 1. The valve 2 is arranged on the air pipe for opening or closing the air passage between the product 1 and the gas storage buffer tank 3.

The terminal 20 at least includes a storage 21, a processor 22, a memory unit 23, and a judging unit 24. The memory unit 23 and the judging unit 24 are connected to the processor 22. The memory unit 23 is configured to store a predetermined critical air pressure value. The processor 22 is adapted to implement instructions. The storage 21 is configured to store a plurality of instructions adapted to be loaded and executed by the processor 22. The processor 22 may be a central processing unit, a digital signal processor, or a single chip microcomputer or the like. Specifically, the processor 22 loads and executes as follows:

turning on the pumping motor 4 in a state where the valve 2 is closed, such that compressed gas is input into the gas storage buffer tank 3 until the instantaneous air pressure value of the pressure gauge 5 reaches a preset air pressure value, the preset air pressure value is larger than the critical air pressure value, and then turning off the pumping motor 4;

maintaining the airtightness detection system 10 standing (not moving) for a preset period in a state where the valve 2 is open, obtaining the instantaneous air pressure value of the pressure gauge 5 during the period of detection, and storing the instantaneous air pressure value of the pressure gauge 5 to the memory unit 23;

controlling the judging unit 24 to obtain the critical air pressure value and the instantaneous air pressure value of the pressure gauge 5, and controlling the judging unit 24 to compare the two. The critical air pressure value and the instantaneous air pressure value are compared, for determining whether the instantaneous air pressure value of the pressure gauge 5 is located between the preset air pressure value and the critical air pressure. Such comparison determines the result of detection of the airtightness of the product 1. Specifically, if the instantaneous air pressure value of the pressure gauge 5 is between the preset air pressure value and the critical air pressure value, the airtightness test of the product 1 is passed, otherwise it is failed.

Preferably, in an embodiment, the airtightness detection system 10 further includes a check valve 6. The check valve 6 is provided between the pumping motor 4 and the gas storage buffer tank 3 for restricting the flow of compressed gas in one direction from the pumping motor 4 to the gas storage buffer tank 3.

Preferably, in an embodiment, the airtightness detection system 10 further includes a display screen 7 arranged on an outside of the fixing seat. The display screen 7 is connected to the terminal 20 for displaying the instantaneous air pressure in the gas storage buffer tank 3.

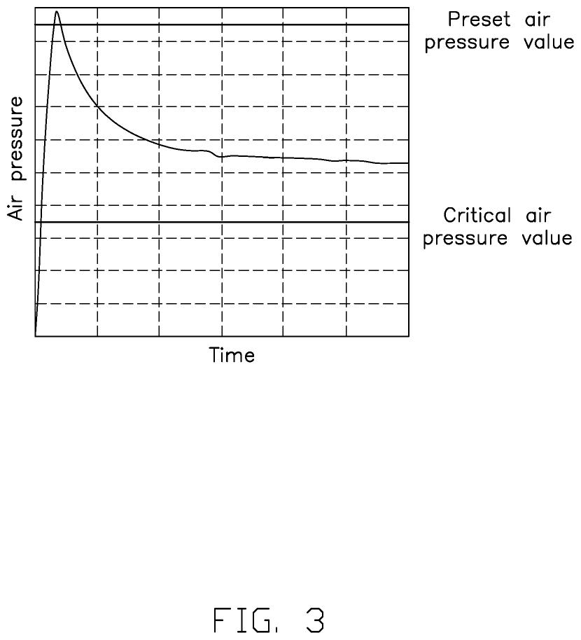

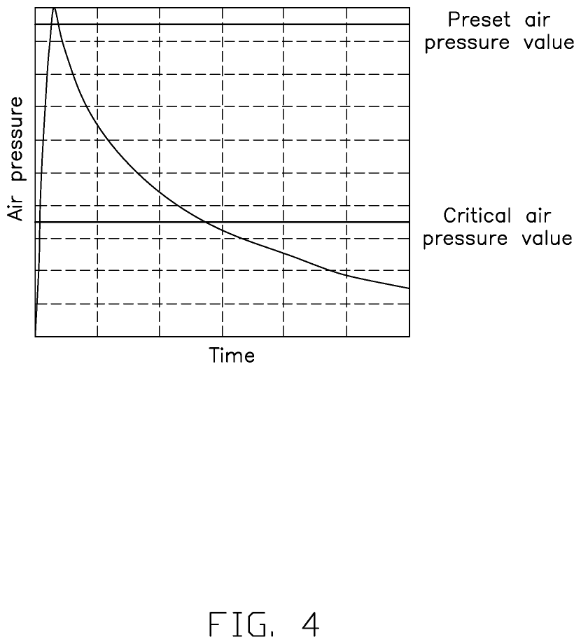

Preferably, in an embodiment, the airtightness detection system 10 further includes an analog-to-digital converter 8. The analog-to-digital converter (ADC) 8 is connected to the pressure gauge 5 and the terminal 20. The analog-to-digital converter 8 is a circuit module for converting an analog signal into a digital signal, and the function thereof is to convert an analog quantity with continuous time and continuous amplitude into a digital signal with discrete time and discrete amplitude. In the present embodiment, the analog-to-digital converter 8 is configured to convert the instantaneous air pressure value in the gas storage buffer tank 3 into a time-discrete, discrete-amplitude air pressure value during the detection period. The processor 22 is further configured to obtain the instantaneous air pressure value converted by the analog-to-digital converter 8 during the detection period and to store the instantaneous air pressure value converted by the analog-to-digital converter 8 in the memory unit 23. The processor 22 is further configured to control the display screen 7 to obtain the instantaneous air pressure value converted by the analog-to-digital converter 8 stored in the memory unit 23, and further to display an instantaneous pressure map of the instantaneous air pressure in the gas storage buffer tank 3 (time-air pressure as the axis) during the detection period, as shown in FIG. 3 and FIG. 4.

Preferably, in an embodiment, the terminal 20 further includes a data analysis unit 25. The data analysis unit 25 is connected to the processor 22 and the memory unit 23. The processor 22 is further configured to control the data analysis unit 25 to obtain the critical air pressure value and the instantaneous air pressure value of the pressure gauge 5 so as to generate the instantaneous pressure comparison map (as shown in FIGS. 3 and 4), and to control the display screen 7 to display the instantaneous pressure comparison map.

Preferably, in an embodiment, the airtightness detection system 10 further includes a scanner 9. The scanner 9 is adjacent to the fixing seat for scanning a code of the product 1. The scanner 9 is connected to the terminal 20. The processor 22 is further configured to obtain the code scanned by the scanner 9, and to store the code in the memory unit 23.

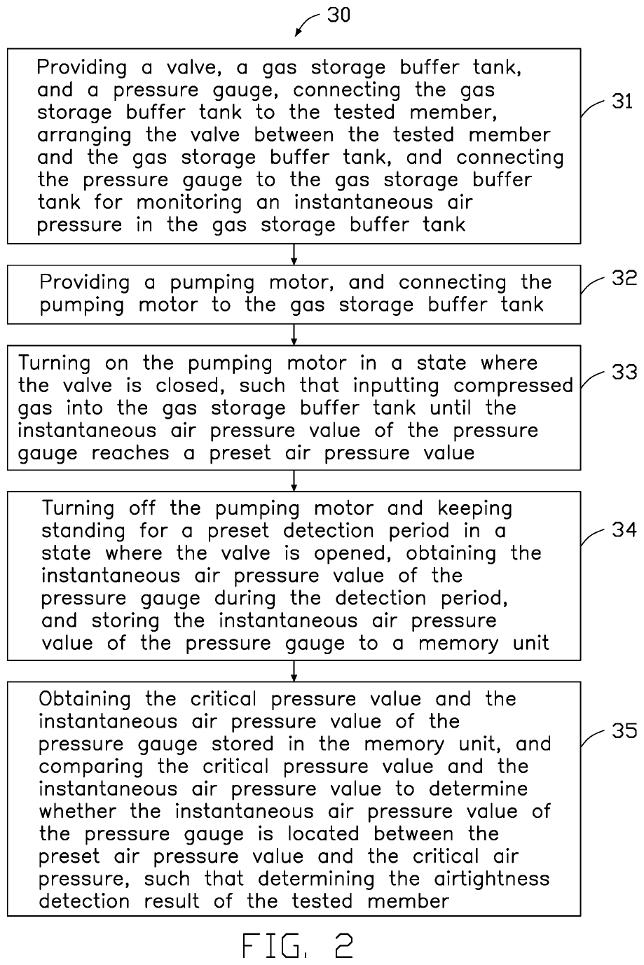

FIG. 2 shows an airtightness detection method 30 for detecting the airtightness of the product 1. The method is provided by way of example, as there are a variety of ways to carry out the method. The airtightness detection method 30 to be described below can be carried out by the module shown in FIG. 2. Each block shown in FIG. 2 represents one or more processes, methods, or subroutines, carried out in the method. Furthermore, the shown order of blocks is illustrative only and the order of the blocks can change. Additional blocks can be added or fewer blocks may be utilized, without departing from this disclosure. The example method can begin at block 31.

Step 31, a valve 2, a gas storage buffer tank 3, and a pressure gauge 5 are provided. The gas storage buffer tank 3 is connected to the product 1, the valve 2 is arranged between the product 1 and the gas storage buffer tank 3, and the pressure gauge 5 is connected to the gas storage buffer tank 3 for monitoring an instantaneous air pressure in the gas storage buffer tank 3.

Step 32, a pumping motor 4 is provided, and the pumping motor 4 is connected to the gas storage buffer tank 3.

Step 33, the pumping motor 4 is turned on in a state where the valve 2 is closed, such that compressed gas is input into the gas storage buffer tank 3 until the instantaneous air pressure value of the pressure gauge 5 reaches a preset air pressure value.

Step 34, the pumping motor 4 is turned off and the airtightness detection system 10 is kept standing for a preset detection period in a state where the valve 2 is open, the instantaneous air pressure value of the pressure gauge 5 during the detection period is obtained and stored to a memory unit 23;

Step 35, the critical air pressure value and the instantaneous air pressure value of the pressure gauge 5 stored in the memory unit 23 are obtained and compared to determine whether the instantaneous air pressure value of the pressure gauge 5 is located between the preset air pressure value and the critical air pressure, such that the result of airtightness detection is determined. Specifically, if the instantaneous air pressure value of the pressure gauge 5 is between the preset air pressure value and the critical air pressure value, the airtightness test of the product 1 is passed, otherwise, it is failed.

Preferably, in an embodiment, after step 31, the airtightness detection method 30 further includes: providing a positioning fixture for carrying and positioning the product 1, and housing the gas storage buffer tank 3, the pumping motor 4, and the pressure gauge 5 in the positioning fixture.

Preferably, in an embodiment, during step 31, the airtightness detection method 30 further includes: providing a check valve 6 between the pumping motor 4 and the gas storage buffer tank 3 for restricting the flow of compressed gas in one direction from the pumping motor 4 to the gas storage buffer tank 3.

Preferably, in an embodiment, the airtightness detection method 30 further includes: providing a display screen 7 on an outside of the positioning fixture, and connecting the display screen 7 to the pressure gauge 5 for displaying the instantaneous air pressure in the gas storage buffer tank 3.

Preferably, in an embodiment, the airtightness detection method 30 further includes: providing an analog-to-digital converter 8 for converting the instantaneous air pressure value in the gas storage buffer tank 3 into a time-discrete, discrete-amplitude air pressure value during the detection period; obtaining the instantaneous air pressure value converted by the analog-to-digital converter 8 during the detection period and storing the instantaneous air pressure value converted by the analog-to-digital converter 8 in the memory unit 23; controlling the display screen 7 to obtain the instantaneous air pressure value converted by the analog-to-digital converter 8 stored in the memory unit 23, and further to display an instantaneous pressure map of the instantaneous air pressure in the gas storage buffer tank 3 (time-air pressure as the axis) during the detection period, as shown in FIG. 3 and FIG. 4.

Preferably, in an embodiment, the airtightness detection method 30 further includes: providing a scanner 9 for scanning an identity code of the product 1, and storing the code of the product 1 in the memory unit 23.

The airtightness detection system 10 and the airtightness detection method 30 of the disclosure monitor the instantaneous air pressure in gas storage buffer tank 3 by using the pressure gauge 5, thereby comparing the instantaneous air pressure in gas storage buffer tank 3 with the preset air pressure value and the critical air pressure value in a preset detection period to determine the air tightness detection result of the product 1, such that the airtightness of the product 1 is tested.

The embodiments shown and described above are only examples. Many such details are found in the relevant art. Therefore, such details are neither shown nor described. Even though numerous characteristics and advantages of the present technology have been set forth in the foregoing description, together with details of the structure and function of the present disclosure, the disclosure is illustrative only, and changes may be made in the details, including in matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. An airtightness detection system for detecting airtightness of a product, comprising:
a gas storage buffer tank adapted to be connected to the product;
a valve between the product and the gas storage buffer tank for opening or closing an air passage between the product and the gas storage buffer tank;
a pumping motor connected to the gas storage buffer tank for inputting compressed gas into the gas storage buffer tank;
a pressure gauge connected to the gas storage buffer tank for monitoring an instantaneous air pressure in the gas storage buffer tank; and
a terminal connected to the pumping motor and the pressure gauge, the terminal comprising:
a memory unit storing a predetermined critical air pressure value;
a judging unit;
a processor adapted to implement instructions; and
a storage storing a plurality of instructions adapted to be loaded and executed by the processor; and
wherein the processor loads and executes:
turning on the pumping motor in a state where the valve is closed, inputting compressed gas into the gas storage buffer tank until the instantaneous air pressure value of the pressure gauge reaches a preset air pressure value; and turning off the pumping motor; wherein the preset air pressure value is larger than the critical air pressure value;
maintaining the airtightness detection system standing for a preset detection period in a state where the valve is open, obtaining the instantaneous air pressure value of the pressure gauge during the detection period, and storing the instantaneous air pressure value of the pressure gauge to the memory unit;
controlling the judging unit to obtain the critical air pressure value and the instantaneous air pressure value of the pressure gauge, and controlling the judging unit to compare the critical air pressure value and the instantaneous air pressure value and to determine whether the instantaneous air pressure value of the pressure gauge is between the preset air pressure value and the critical air pressure, and to determine the airtightness detection result of the product.

2. The airtightness detection system of claim 1, further comprising a check valve, wherein the check valve is between the pumping motor and the gas storage buffer tank for restricting the flow of compressed gas in one direction from the pumping motor to the gas storage buffer tank.

3. The airtightness detection system of claim 1, further comprising a display screen, wherein the display screen is connected to the terminal for displaying the instantaneous air pressure in the gas storage buffer tank and the airtightness detection result determined by the judging unit.

4. The airtightness detection system of claim 3, further comprising an analog-to-digital converter, wherein the analog-to-digital converter is connected to the pressure gauge and the terminal, the analog-to-digital converter is configured to convert the instantaneous air pressure value in the gas storage buffer tank into a time-discrete, discrete-amplitude air pressure value during the detection period; the processor is further configured to obtain the instantaneous air pressure value converted by the analog-to-digital converter during the detection period and to store the instantaneous air pressure value converted by the analog-to-digital converter in the memory unit; the processor is further configured to control the display screen to obtain and to display the instantaneous air pressure value converted by the analog-to-digital converter stored in the memory unit.

5. The airtightness detection system of claim 3, further comprising a data analysis unit, wherein the data analysis unit is connected to the processor and the memory unit, the processor is further configured to control the data analysis unit to obtain the critical air pressure value and the instantaneous air pressure value of the pressure gauge, generate an instantaneous pressure comparison map, and control the display screen to display the instantaneous pressure comparison map.

6. The airtightness detection system of claim 1, further comprising a scanner for scanning a code of the product, wherein the scanner is connected to the terminal, the processor is further configured to obtain the code scanned by the scanner, and to store the code in the memory unit.

7. An airtightness detection method for detecting airtightness of a product, comprising:
providing a valve, a gas storage buffer tank, and a pressure gauge, connecting the gas storage buffer tank to the product, arranging the valve between the product and the gas storage buffer tank, and connecting the pressure gauge to the gas storage buffer tank for monitoring an instantaneous air pressure in the gas storage buffer tank;
providing a pumping motor, and connecting the pumping motor to the gas storage buffer tank;
turning on the pumping motor in a state where the valve is closed, inputting compressed gas into the gas storage buffer tank until the instantaneous air pressure value of the pressure gauge reaches a preset air pressure value;
turning off the pumping motor and maintaining standing for a preset detection period in a state where the valve is open, obtaining the instantaneous air pressure value of the pressure gauge during the detection period, and storing the instantaneous air pressure value of the pressure gauge to a memory unit;
obtaining the critical air pressure value and the instantaneous air pressure value of the pressure gauge stored in the memory unit, and comparing the critical air pressure value and the instantaneous air pressure value to determine whether the instantaneous air pressure value of the pressure gauge is located between the preset air pressure value and the critical air pressure, such that determining the airtightness detection result of the product.

8. The airtightness detection method of claim 7, wherein during “providing a pumping motor, and connecting the pumping motor to the gas storage buffer tank”, the airtightness detection method further comprises: providing a check valve between the pumping motor and the gas storage buffer tank for restricting the flow of compressed gas in one direction from the pumping motor to the gas storage buffer tank.

9. The airtightness detection method of claim 8, further comprising: providing a display screen connected to the pressure gauge, the display screen is configured to display the instantaneous air pressure in the gas storage buffer tank.

10. The airtightness detection method of claim 9, further comprising: providing an analog-to-digital converter for converting the instantaneous air pressure value in the gas storage buffer tank into a time-discrete, discrete-amplitude air pressure value during the detection period; obtaining the instantaneous air pressure value converted by the analog-to-digital converter during the detection period and storing the instantaneous air pressure value converted by the analog-to-digital converter in the memory unit; controlling the display screen to obtain and further display the instantaneous air pressure value converted by the analog-to-digital converter stored in the memory unit during the detection period.
